(19) United States
(12) Patent Application Publication
(10) Pub. No.: US 2018/0347767 A1
(43) Pub. Date: Dec. 6, 2018

(54) LIGHTING FIXTURE

(71) Applicant: LTS Licht & Leuchten GmbH, Tettnang (DE)

(72) Inventor: Erich Koepplin, Weingarten (DE)

(21) Appl. No.: 15/995,532

(22) Filed: Jun. 1, 2018

(30) Foreign Application Priority Data
Jun. 1, 2017 (DE) EP 17 173 870.1

(51) Int. Cl. F21S 4/28; G02B 27/09; F21V 14/00

(52) U.S. Cl. CPC F21S 4/28; F21V 14/006; G02B 27/0955

(57) ABSTRACT

A lighting fixture (1) comprising:
a strip (5) configured as a U-profile in which at least one guide path (9) is worked into both the legs (6, 7) which run parallel to one another
a large number of LEDs (light-emitting diodes) (10) attached to the strip (5), by means of which the light waves are emitted in a lighting spread (11), and
at least one light wave divider (12) that can be inserted into two guide paths (9) running parallel to one another,
   should firstly make possible the required illumination of rooms and, secondly, significantly reduce installation and manufacturing costs of the lighting fixture (1) compared to the lighting fixtures of prior art. These tasks are accomplished in that,
the light wave divider (12) is configured as a thin-walled foil with bending flexibility,
at least one optical structure (14) is provided on or in the foil (12) is, and is arranged in the lighting spread (11) of the LEDs,
and that the foil (12) runs continuously along the entire length of the strip (5) when installed

### REFERENCE TO PENDING PRIOR PATENT APPLICATION

This patent application claims benefit of European Patent Application No. 17 173 870.1, filed Jun. 1, 2017, which patent application is hereby incorporated herein by reference.

### FIELD OF THE INVENTION

The present invention relates to a lighting fixture in accordance with the pre-characterising clauses of patent claim 1.

### BACKGROUND OF THE INVENTION

Lighting fixtures of this kind have been disclosed, for example, in EP 1 850 061 A1 and are used for illuminating goods for sale in shelf units as a means of making them more attractive for sale. These lighting fixtures are attached to, in particular, ceilings of supermarkets or other businesses and comprise a U-shaped strip with a length that is significantly larger than its width. A large number of LEDs are attached in the strip and emit light waves. Consequently, the LEDs emit light along a three-dimensional lighting spread from the strip in the direction of the floor. A light divider is provided between the two legs of the strip which run parallel to one another and is formed as a plate that is resistant to bending. Each of the two legs which run parallel to one another has a guide path worked into it, and these paths run flush with one another. The light divider can be pushed into the guide paths.

The light divider has an optical structure in the form of a lens or the like worked into it, by means of which the light waves emitted by the LEDs are directed in a specified direction.

It is a disadvantage that a large number of light dividers of this kind have to be pushed into the strip which is several metres in length, because due to their optical structures the light dividers cannot be produced over a specified length. In addition, the plate-shaped light dividers expand during operation of the LEDs as a result of the warmth that they generate, with the result that an air gap must be provided between two adjacent light dividers by means of which the corresponding lengthways expansion of the light dividers is made possible. As a result of the geometrical dimensions of the light divider, the spread in the lengthways direction, i.e. parallel to the strip, is significantly greater than in the crossways direction which necessitates the air gap between the adjacent light dividers or insertion of the light dividers at the end into the front end of the strip.

The manufacturing costs of such light dividers are high, because the optical structure is extremely complicated to produce.

### SUMMARY OF THE INVENTION

The task of the present invention is therefore to develop a lighting fixture of the aforementioned kind in such a way that, firstly, the required illumination of rooms is made possible and, secondly, that installation and manufacturing costs of the lighting fixture are significantly reduced compared to the lighting fixtures of prior art.

These tasks are accomplished by the features in the pre-characterising clause of patent claim 1.

Further advantageous configurations of the invention are disclosed in the subordinated claims.

The light wave divider is configured as a thin-walled foil with bending flexibility, an optical structure is provided on or in the foil which is arranged in the lighting spread of the LEDs, and the foil runs continuously along the entire length of the strip when installed, as a result of which features the lighting fixture can be produced with low manufacturing and installation costs without any impairment of the lighting properties because the structure can be inexpensively manufactured on the foil, and the foil is incorporated into the lighting fixture by being unwound and pushed in.

Moreover, the foil can expand along the entire length of the strip because the heat emitted by the LEDs only changes the dimensions of the foil by a small amount, due to its thin-walled properties.

The wall thickness of the foil which is between 0.3 mm and 0.7 mm means that the foil consequently has bending flexibility and can be wound on a roll for transport, storage and installation purposes. Moreover, the foil is provided with any required optical properties, which can be adapted to the particular customer's requirements, by means of its specifically required optical structure which, in a preferred embodiment, is configured with Fresnel lens technology.

### BRIEF DESCRIPTION OF THE DRAWINGS

The drawing shows a sample embodiment configured in accordance with the present invention, the details of which are explained below. In the drawing,

FIG. 1 shows lighting fixture with a U-shaped strip into which a large number of LEDs is installed, and which is attached to the ceiling of a room, with a foil pushed into the strip by means of which the light waves of the LEDs are directed into a preferred lighting spread in the room, as a perspective view,

FIG. 2 shows a magnified view of the lighting fixture in accordance with FIG. 1 in the installed condition,

FIG. 3a shows an embodiment variant of the foil in accordance with FIG. 1 with a circular optical structure, and

FIG. 3b shows a second embodiment variant of the foil in accordance with FIG. 1 with a polygonal or optical structure.

### DETAILED DESCRIPTION OF THE PREFERRED EMBODIMENTS

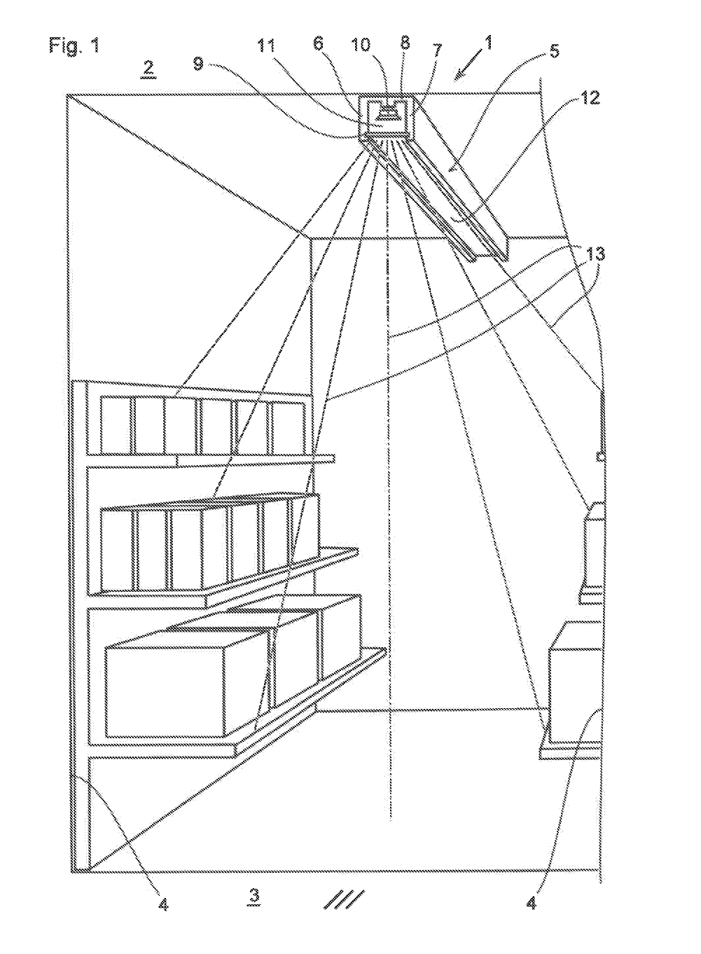

FIG. 1 shows a lighting fixture 1 which is attached to the ceiling 2 of a room. The lighting fixture 1 is intended to illuminate a floor 3 and two walls 4 running parallel to one another.

The lighting fixture 1 comprises a strip 5 with a U-shaped cross-section. The two legs of the strip 5 running parallel to one another are identified with the reference numbers 6 and 7. The bar connecting the two legs 6 and 7 together is identified with the reference number 8. The bar 8 consequently runs along the ceiling 2 and is attached to it.

Each of the two legs 6 and 7 has a guide path 9 worked into it with a U-shaped cross-section. The two guide paths 9 which run opposite one another are at an identical height, and consequently run flush with one another.

The bar 8 of the strip 5 has a large number of LEDs 10 attached to it, which are energised. The LEDs 10 emit or radiate light waves which run in the direction of the floor 3 and of both walls 4. Within the strip 5, the light waves emitted by the LEDs 10 are present within a lighting spread identified by the reference number 11.

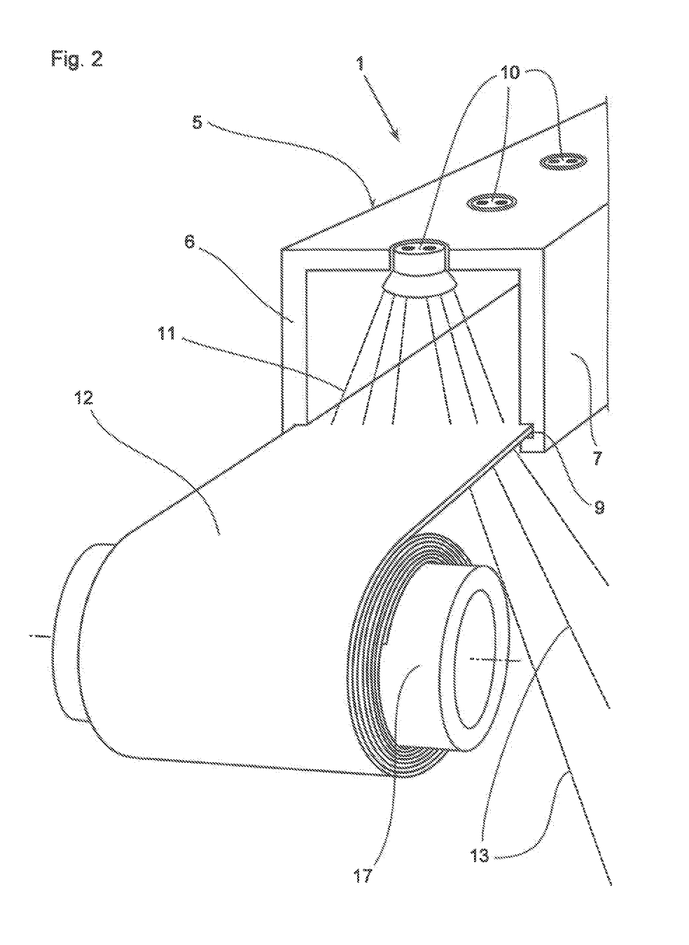

FIG. 2 in particular shows that each of the two guide paths 9 has a light wave divider 12 arranged in it in the form of a thin-walled foil. The foil 12 has bending flexibility and can be bonded into the guide paths 9. The foil 12 is provided or equipped with an optical structure 14, as explained in more detail below. The optical structure 14 can be configured as what is referred to as a Fresnel lens structure, with the effect that the light divider 12 directs the lighting spread 11 into a subsequent lighting spread 13. Accordingly, the lighting spread 13 extends into the area occupied by the light waves after they have penetrated the light divider 12. Often, it is desirable for the floor 3 to be illuminated less than the walls 4 because shelf units containing goods run along the walls 4 and the goods should be presented in an optically appealing way.

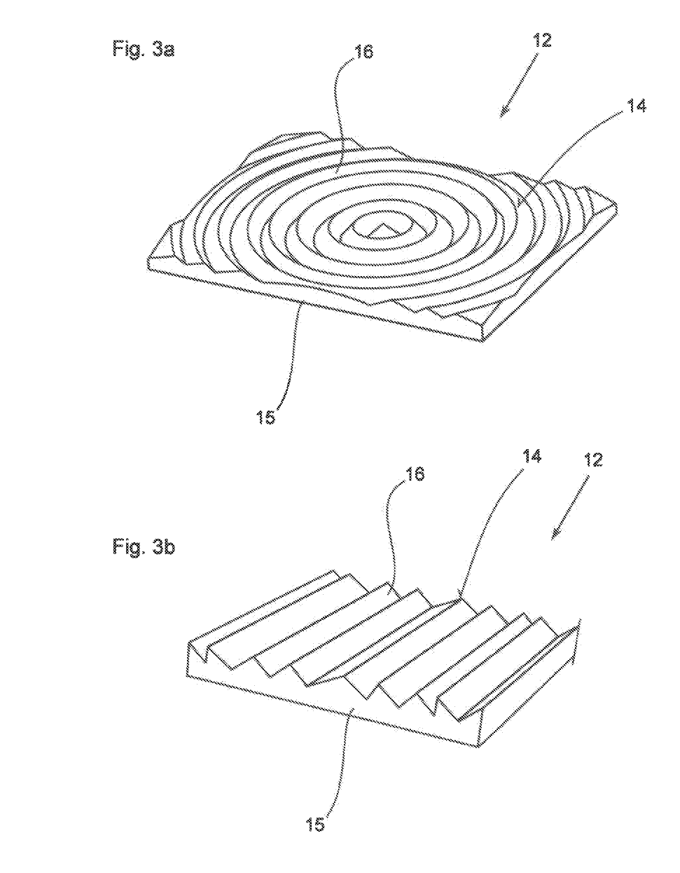

FIGS. 3a and 3b shows the design structure of the foil 12. A first layer 15, which is to be regarded as a carrier layer and is manufactured from a plastic, has a second layer 16 applied to it in the form of a liquid polymer which is given a particular structure subsequently by means of a roller that is not illustrated. As soon as the roller has formed the polymer layer 16 into a specified optical structure 14 by means of pressure, a UV light is used for hardening the polymer layer 16. The hardened polymer layer 16 has a lens appearance by means of which the light waves passing through the foil 12 are transformed from the lighting spread 11 into the lighting spread 13. As a result, any light diffractions and deflections can be achieved by the optical structure 14 of the foil 12.

In accordance with FIG. 2, the bending flexibility of the foil 12 means that it can be wound onto a roll 17 for transport and storage purposes. As soon as the strip 5 has been attached to the ceiling 2, the foil 12 is pushed into the two guide paths 9 that run parallel to one another. The foil 12 subsequently extends along the entire length of the strip 5 meaning that a completely closed strip 5 is created. The heat emitted by the LEDs does cause the foil 12 to undergo slight expansion, however this spatial expansion of the foil 12 can be absorbed at both front ends of the strip 5, because a cover or a panel is inserted into the ends of the strip 5, into which the foil 12 can extend following its thermal expansion.

The wall thickness of the foil 12, and namely both layers 15 and 16 together, is 0.5 mm in the sample embodiment shown in FIGS. 1 to 3b. The foil 12 should be able to be wound on the roll 17 and has a corresponding optical structure 14, with the result that not only bending flexibility but also a particular wall thickness should be provided for inherent stability. Consequently, the wall thickness of the foil is at least 0.3 and at most 0.7 mm. If the wall thickness of the foil 12 is greater than 0.7 mm then the bending flexibility of the foil 12 will be lost; and if the wall thickness of the foil 12 is less than 0.3 mm then the foil 12 will lose its shape stability or resilience.

The pressure-formed optical structure 14 of the foil 12 as shown in FIG. 3b runs at right angles to the strip 5. It is clear that the illustrated optical structure 14 is only an example and any required contour can be achieved, preferably one with a linear or polygonal shape.

1. A lighting fixture (1) comprising:
a strip (5) configured as a U-profile in which at least one guide path (9) is worked into both the legs (6, 7) which run parallel to one another
a large number of LEDs (light-emitting diodes) (10) attached to the strip (5), by means of which the light waves are emitted in a lighting spread (11), and
at least one light wave divider (12) that can be inserted into two guide paths (9) running parallel to one another,
characterised in that,
the light wave divider (12) is configured as a thin-walled foil with bending flexibility,
at least one optical structure (14) is provided on or in the foil (12) is, and is arranged in the lighting spread (11) of the LEDs,
and that the foil (12) runs continuously along the entire length of the strip (5) when installed.

2. The lighting fixture in accordance with claim 1, characterised in that, the foil (12) consists of at least two layers (15, 16) which are connected to one another in the particular parting plane, that the optical structure (14) is arranged in one of the layers (15, 16) of the foil (12) or in the parting plane between two adjacent layers (15, 16) of the foil (12), and that the optical structure (14) is configured as a Fresnel lens structure, preferably in a linear or polygonal optical structure.

3. The lighting fixture in accordance with claim 1, characterised in that, The foil (12) is configured as an endless strip and that the foil (12) can be wound on a roll (17) for installation, transport and storage purposes.

4. The lighting fixture in accordance with claim 3, characterised in that, The foil (12) can be unwound from the roll (17) during the process of pushing it into the guide paths (9) of the strip (5).

5. The lighting fixture in accordance with claim 1, characterised in that, The foil (11) has a wall thickness of 0.3 to 0.7 mm, preferably 0.5 mm.
